(19) United States
(12) Patent Application Publication
(10) Pub. No.: US 2008/0012462 A1
(43) Pub. Date: Jan. 17, 2008

(54) ELECTRON EMISSION ELEMENT, METHOD OF MANUFACTURING ELECTRON EMISSION ELEMENT, AND DISPLAY DEVICE WITH ELECTRON EMISSION ELEMENT

(75) Inventor: Masashi Yamage, Yokohama-shi (JP)

Correspondence Address: PEARNE & GORDON LLP, 1801 EAST 9TH STREET, SUITE 1200, CLEVELAND, OH, 44114-3108, US

(73) Assignee: KABUSHIKI KAISHA TOSHIBA, Tokyo (JP)

(21) Appl. No.: 11/684,851

(22) Filed: Mar. 12, 2007

(30) Foreign Application Priority Data
Jul. 12, 2006 (JP) 2006-192023
Aug. 24, 2006 (JP) 2006-228144

(51) Int. Cl. H01J 1/02; H01J 9/02

(52) U.S. Cl. 313/310; 445/51

(57) ABSTRACT

An electron emission element includes a substrate, a first conductive layer provided on the substrate, an electron emission part formed on the first conductive layer, an insulating layer formed on the first conductive layer and having a first opening part arranged such that the electron emission part is located within the first opening part, and a second conductive layer formed on the insulating layer and having a second opening part such that the electron emission part is located within the second opening part, wherein an electric-field concentration part which concentrates an electric field is provided within the second opening part.

### CROSS-REFERENCE TO RELATED APPLICATIONS

This application is based upon and claims the benefit of priority from prior Japanese Patent Applications No. 2006-192023, filed Jul. 12, 2006; and No. 2006-228144, filed Aug. 24, 2006, the entire contents of both of which are incorporated herein by reference.

### BACKGROUND OF THE INVENTION

1. Field of the Invention

The present invention relates to an electron emission element used in a display device or the like, a method of manufacturing the electron emission element, and a display device having the electron emission element.

2. Description of the Related Art

A field emission display (FED) using an electron emission element has been known as one type of the display device, as disclosed in Jpn. Pat. Appln. KOKAI Publication No. 2004-186015 (FIG. 1). The electron emission element having a three-electrode structure including a gate electrode is known. In this type of electron emission element, a cathode electrode layer and an electron emitting layer are formed on a glass substrate, and a planar gate electrode layer is formed on the assembly, with an insulating layer being interlayered therebetween. Openings are formed in the gate electrode layer. The electron emission layer is exposed through the openings. Usually, the openings are circular in shape. The inner surface of the opening is flat and has a fixed diameter as viewed in the thickness direction. An electron emission part is formed on the exposed electron emission layer within the opening. Voltage required for electron emission varies depending on a distance between the electron emission part and the gate electrode, the area of the tip of the electron emission part and the like. Here, the necessary power is reduced by using carbon nanotubes (CNTs) having narrow tips for the electron emission part.

The opening of the gate electrode layer in the electron emission element having the structure stated above is circular in shape and has a fixed diameter as viewed in the thickness direction, and the inner surface of the opening is flat. For this reason, the electric field is hard to concentrate.

The display device is provided with equidistantly arrayed electron emission element and a display portion. The electron emission element is constructed such that a cathode electrode layer is formed on a glass substrate, for example, and electron emitting layers having electron emission parts are formed on the cathode electrode layer. On the other hand, the display portion includes gate electrodes formed in association with the electron emission parts and an anode electrode. When a predetermined voltage is applied to the cathode electrode layer, the gate electrode layer and the anode layer of the assembly in a reduced pressure state, the electron emission parts emit electrons and the electrons hit the display portion to emit light. Even in the reduced pressure state, however, materials of, for example, residual gas of hydrogen, oxygen and the like are left around the electron emission parts. The materials of the residual gas and the like, which are present around the electron emission parts, sometimes adversely affect the electron emission parts. For example, the materials such as the residual gas present in a pressure-reduced atmosphere sometimes adsorb to the electron emission parts to oxidize or degrade the surfaces of the electron emission parts. The surface oxidization or degradation possibly leads to reduction of the quantities of electrons emitted from the electron emission parts and performance degradation of the electron emission parts. It is a common practice that materials of the residual gas and the like are reduced by increasing the vacuum level around the electron emission parts to thereby prevent the performance degradation, which arises from the surface oxidization or degradation.

### BRIEF SUMMARY OF THE INVENTION

According to an aspect of the present invention, an electron emission element comprises, a substrate, a first conductive layer provided on the substrate, an electron emission part formed on the first conductive layer, an insulating layer formed on the first conductive layer and having a first opening part arranged such that the electron emission part is located within the first opening part, and a second conductive layer formed on the insulating layer and having a second opening part such that the electron emission part is located within the second opening part, wherein an electric-field concentration part which concentrates an electric field is provided within the second opening part.

According to an aspect of the present invention, an electron emission element comprises, a substrate, a first conductive layer provided on the substrate via an insulating layer, an electron emission part formed on the first conductive layer, and a second conductive layer formed on the substrate via an insulating layer, while being separated from the first conductive layer in the plane direction of the substrate, wherein an electric-field concentration part which concentrates an electric field is provided at a part of the second conductive layer, which faces the electron emission part.

According to an aspect of the present invention, a method of manufacturing an electron emission element comprises, forming a first conductive layer on a substrate, forming an insulating layer on the first conductive layer, forming a second conductive layer on the insulating layer, placing a mask, having an opening part with a predetermined shape, on the second conductive layer, etching the second conductive layer by using the mask, and forming an opening part with an extended part in the second conductive layer, etching the insulating layer within the opening part to expose the first conductive layer, and forming an electron emission part on the first conductive layer.

According to an aspect of the present invention, a method of manufacturing an electron emission element comprises, forming a first conductive layer on a substrate, forming an insulating layer on the first conductive layer, forming a second conductive layer on the insulating layer, placing a mask, having an opening part with a predetermined shape, on the second conductive layer, etching the second conductive layer by using the mask, and forming an opening part in the second conductive layer, supplying a gas containing fluorine to the opening part to etch the insulating layer to expose the first conductive layer, and forming a part extending to the inner side of the opening part in the second conductive layer, and forming an electron emission part on the first conductive layer.

According to an aspect of the present invention, a display device comprises, an electron emission element including a substrate, a first conductive layer provided on the substrate, an electron emission part formed on the first conductive layer, an insulating layer formed on the first conductive layer and having a first opening part arranged such that the electron emission part is located within the first opening part, and a second conductive layer formed on the insulating layer and having a second opening part such that the electron emission part is located within the second opening part, wherein an electric-field concentration part which concentrates an electric field is provided within the second opening part, and a display portion which receives electrons emitted from the electron emission part to emit light.

According to an aspect of the present invention, a display device comprises, an electron emission element including a substrate, a first conductive layer provided on the substrate via an insulating layer, an electron emission part formed on the first conductive layer, and a second conductive layer formed on the substrate via an insulating layer, while being separated from the first conductive layer in the plane direction of the substrate wherein an electric-field concentration part which concentrates an electric field is provided at a part of the second conductive layer, which faces the electron emission part, and a display portion which receives electrons emitted from the electron emission part to emit light.

According to an aspect of the present invention, an electron emission element comprises, a substrate, a conductive layer layered on the substrate, an electron emission layer having an electron emission part formed on the conductive layer, and a coating member which covers the electron emission parts and is made of a material harder to be oxidized than the electron emission part.

According to an aspect of the present invention, a method of manufacturing an electron emission element comprises, forming a conductive layer on a substrate, forming an electron emission layer with an electron emission part on the conductive layer, and forming a coating member on the surface of the electron emission part, the coating member being harder to be oxidized than the surface of the electron emission part.

According to an aspect of the present invention, a display device comprises, an electron emission element including a substrate, a conductive layer layered on the substrate, an electron emission layer having an electron emission part formed on the conductive layer, and a coating member which covers the electron emission parts and is made of a material harder to be oxidized than the electron emission part, and a display portion which receives electrons emitted from the electron emission part to emit light.

### BRIEF DESCRIPTION OF THE SEVERAL VIEWS OF THE DRAWING

The accompanying drawing, which are incorporated in and constitute a part of the specification, illustrate embodiments of the invention.

FIG. 1 is a perspective view showing in model form a portion of an image display device according to a first aspect of the present invention;

FIG. 2 is an enlarged cross-sectional view showing in model form a key portion of the image display device;

FIG. 3 is an enlarged plan view showing in model form a key portion of the image display device;

FIG. 4 is a cross-sectional view showing in model form a step for forming emitter holes in a method of manufacturing an electron emission element according to the first embodiment of the invention;

FIG. 5 is an enlarged cross-sectional view showing in model form a key portion of an image display device according to a second embodiment of the invention;

FIG. 6 is an enlarged plan view showing in model form a key portion of the image display device;

FIG. 7 is an enlarged cross-sectional view showing in model form a key portion of an image display device according to a third embodiment of the invention;

FIG. 8 is an enlarged plan view showing in model form a key portion of the image display device;

FIG. 9 is an enlarged cross-sectional view showing in model form a key portion of an image display device according to a fourth embodiment of the invention;

FIG. 10 is an enlarged plan view showing in model form a key portion of the image display device;

FIG. 11 is an enlarged cross-sectional view showing in model form a key portion of an image display device according to a fifth embodiment of the invention;

FIG. 12 is an enlarged plan view showing in model form a key portion of the image display device;

FIG. 13 is an enlarged cross-sectional view showing in model form a key portion of an image display device according to a sixth embodiment of the invention;

FIG. 14 is an enlarged plan view showing in model form a key portion of the image display device;

FIG. 15 is a perspective view showing in model form a part of an image display device according to a seventh embodiment of the invention;

FIG. 16 is an enlarged cross-sectional view showing in model form a key portion of the image display device;

FIG. 17 is a side view showing in model form the key portion, partially cut out, of FIG. 16;

FIG. 18 is a cross-sectional view showing in model form a portion of an image display device according to an eighth embodiment of the invention;

FIG. 19 is a side view showing in model form a key portion, partially cut out, of the image display device;

FIG. 20 is a cross-sectional view showing in model form a portion of an image display device according to a ninth embodiment of the invention;

FIG. 21 is a side view showing in model form a key portion, partially cut out, of the image display device;

FIG. 22 is a cross-sectional view showing in model form a portion of an image display device according to a tenth embodiment of the invention;

FIG. 23 is a side view showing in model form a key portion, partially cut out, of the image display device;

FIG. 24 is a cross-sectional view showing in model form a portion of an image display device according to an eleventh embodiment of the invention; and

FIG. 25 is a side view showing in model form a key portion, partially cut out, of the image display device.

### DETAILED DESCRIPTION OF THE INVENTION

Embodiments of the present invention will be described with reference to the accompanying drawings.

### First Embodiment

First, description will be given about an electron emission element, a method of manufacturing the electron emission element, and a display device having the electron emission element according to a first embodiment of the present invention.

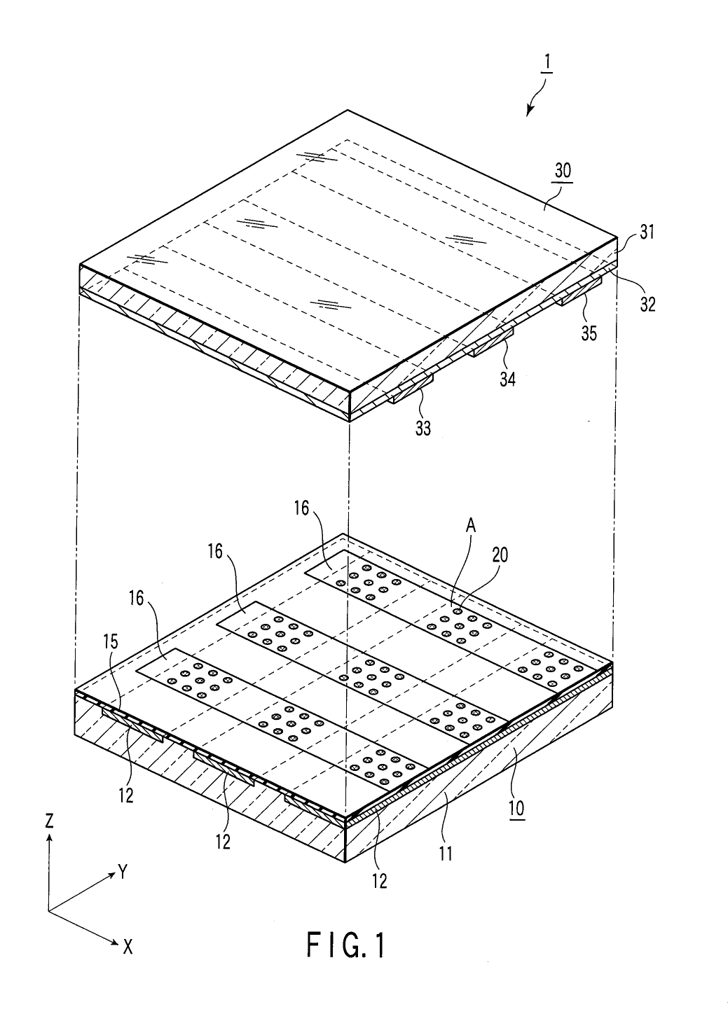

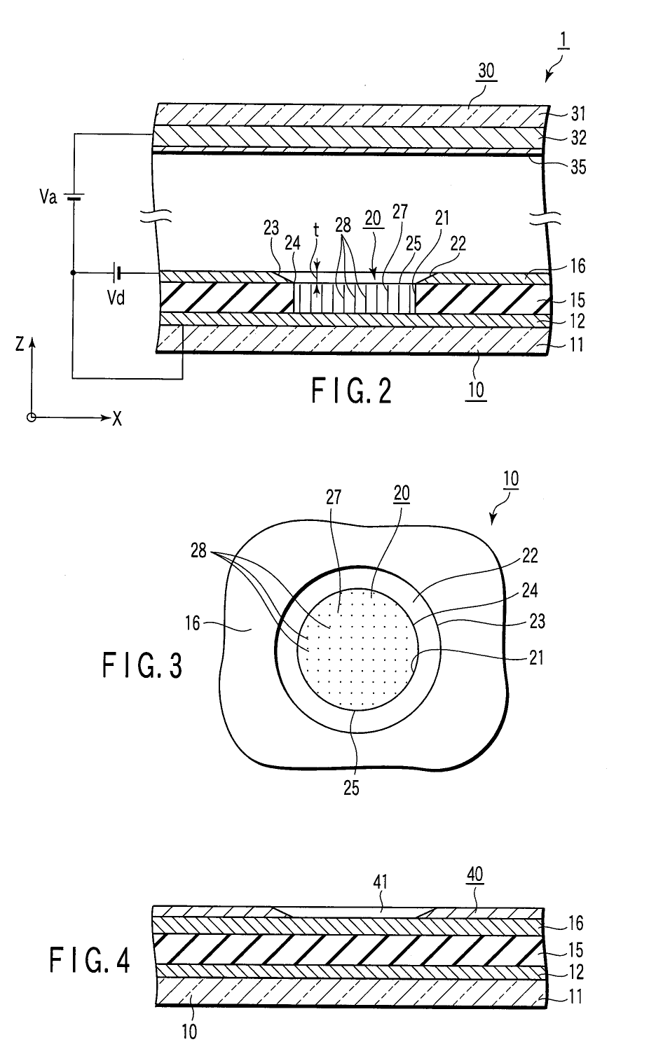

An image display device 1, an electron emission element 10 and the like according to the first embodiment of the invention will be described with reference to FIGS. 1 to 3. FIG. 1 is a perspective view showing a portion corresponding to one pixel in the image display device. FIG. 2 is an enlarged cross-sectional view showing a portion A in the image display device of FIG. 1. FIG. 3 is an enlarged plan view showing the portion A of the electron emission element 10 in FIG. 1. Arrows X, Y and Z in FIGS. 1 and 2 indicate respectively three directions, which are orthogonal to one another.

As shown in FIG. 1, the image display device 1 is generally composed of the electron emission element 10 and a display portion 30 for emitting light upon receipt of electrons emitted from the electron emission element 10. The electron emission element 10 and the display portion 30 are bonded to each other in a state that those are oppositely disposed with a given space therebetween.

The electron emission element 10 shown in FIGS. 1 and 2 is made up of a cathode substrate 11 as a substrate, a plurality of conductive layers 12 as first conductive layers formed on the cathode substrate 11, an insulating layer 15 formed on the conductive layers 12, and a plurality of gate electrodes 16 as second conductive layers formed on the insulating layer 15. Emitter holes 20, which are each one form of an opening part, are formed in the insulating layer 15 and the gate electrodes 16, and within each emitter hole 20, a carbon layer 27 as an electron emitting layer is formed on each conductive layer 12.

The cathode substrate 11 is made of glass, silicon or the like, and has an area large enough to display an image. In the embodiment, a plurality of conductive layers 12 are arrayed in parallel on the cathode substrate 11 corresponding to one pixel. For example, the conductive layers 12 are made of a catalyst metal such as nickel and each take a rectangular shape extending in the Y direction.

As shown in FIGS. 1 and 2, the insulating layer 15 is made of silicon oxide or the like and is formed on the upper surfaces of the cathode substrate 11 and the conductive layers 12.

The plurality of gate electrodes 16 are made of a metal such as aluminum, and each take a rectangular shape extending in the X direction. Those gate electrodes 16 are arrayed corresponding in positions to fluorescent members 33 to 35 of three colors. Those gate electrodes 16 are connected to a driving circuit and matrix controlled.

As shown in FIG. 1, an array of the emitter holes 20 is formed in each of the crossing portions where the gate electrodes 16 cross the conductive layers 12, with the insulating layer 15 interlayered therebetween. As shown in FIG. 2, the emitter holes 20 are formed by removing only the gate electrodes 16 and the insulating layer 15 by etching process, for example. In each emitter hole 20 being circular when viewed in transverse section, an insulation hole part 21 as a first opening part formed in the insulating layer 15 is continuous to a gate hole part 22 as a second opening part formed in the gate electrodes 16.

The gate hole part 22 is circular when viewed in transverse section and trapezoidal when viewed in longitudinal section. The opening diameter of the gate hole part reduces from the upper end thereof to the lower end when viewed in the figure. The inner surface of the gate hole part 22 of the gate electrode 16 is formed such that the lower on the inner surface, that is the closer in the width direction to the tips of the CNTs 28, the closer to the center of the emitter hole 20, that is the closer in the plane direction to the tips of CNTs 28.

The upper end of the inner surface of the gate hole part 22 forms a large diameter part 23 defining a maximum diameter of the gate hole part, and the lower end thereof forms a small diameter part 24 defining a minimum diameter thereof. The small diameter part 24 is an electric-field concentration part 25. A difference between the maximum radius and the minimum radius is larger than a thickness “t” of the gate electrodes 16. In the present embodiment, it is about 3 times of the thickness “t” of the gate electrodes 16.

As shown in FIG. 2, the inner surface of the gate hole part 22 is slanted and the gate electrode 16 is sharpened toward the center of the gate hole part 22. As the lower end of the inner surface of the gate hole part 22 approaches the center of the gate hole part, the area of the gate hole part as longitudinally viewed becomes small.

The insulation hole part 21 extends continuously and downwardly from the lower end of the gate hole part 22. An inner diameter of the insulation hole part 21 is equal to the small diameter part 24, and keeps its dimension constant as viewed in its thickness direction (Z direction).

As shown in FIGS. 2 and 3, a carbon layer 27 as an electron emission layer is uniformly formed on the conductive layer 12 within each emitter hole 20. The carbon layer 27 is formed with a number of CNTs 28, which rise in a brush fashion toward the display portion 30, i.e., in the Z direction. The tips of the CNTs form an example of an electron emission part. The CNT 28 is shaped like a roll of a graphene sheet. The CNT 28 is about 50 nm in diameter and about 1 μm in length, and has a high tolerance current density. The CNT emits electrons upon application of low voltage in a pressure-reduced state. The tips of the CNTs 28 as the electron emission part are lower than the gate electrodes 16.

The display portion 30 shown FIGS. 1 and 2 includes an anode substrate 31, an anode electrode 32 formed on the anode substrate 31, and the fluorescent members 33 to 35 of three colors R, G, and B, which are coated on the surface of the anode electrode 32.

The anode substrate 31 is made of a transparent material such as glass, which is the same as the cathode substrate 11, in order to secure good sealing in connection with the cathode substrate 11. The anode electrode 32, made of metal, e.g., aluminum, is formed facing the cathode substrate 11. The anode electrode 32 is connected to a driving circuit. The fluorescent members 33 to 35 of three colors are rectangular and extends in the X direction, and respectively arranged in opposition to the gate electrodes 16, the electron emission element 10 and the display portion 30 are bonded with each other by securing a predetermined width of a gap therebetween with a spacer, not shown. The gap is in a pressure-reduced state, and this state is well maintained with a getter, not shown. The gap is in a pressure-reduced state, and this state is well maintained with a getter, not shown.

A method of manufacturing the electron emission element 10 according to the first embodiment of the invention, will be described hereunder. To start, a nickel plate is attached to the cathode substrate 11 made of glass to form conductive layers 12. An insulating layer 15 is formed on the conductive layers 12 and the entire upper surface of the cathode substrate 11 on which the conductive layers 12 are not formed. A film made of a metal, e.g., aluminum, which is different from the catalyst metal of the conductive layers 12, is formed on the insulating layer 15 by a sputtering process to thereby form the gate electrodes 16.

Emitter holes 20 are formed at predetermined positions such that the emitter holes pass through the gate electrodes 16 and the insulating layer 15 to allow the catalyst metal to be exposed through the holes. Specifically, as shown in FIG. 4, a mask 40 having circular opening parts 41 is first placed on the gate electrodes 16. Each of the circular opening parts 41 is shaped such that the diameter of the circular opening part gradually reduces from the upper end thereof to the lower end. Thereafter, the gate electrodes 16 placed under the mask 40 are dry etched by using a given etching gas to form the gate hole parts 22. Subsequently, the insulating layer 15 is dry etched from the gate hole part 22 up to the conductive layers 12 by using a given etching gas to thereby form the emitter holes 20 each having a predetermined configuration.

After the emitter holes 20 are formed, the cathode substrate 11 is introduced into a vacuum container, and CNTs 28 are formed on the exposed conductive layers 12 by decomposing a mixture gas of methane and hydrogen in plasma.

For example, the conductive layers 12 are made of a catalyst metal such as nickel. In this case, the conductive layers 12 serve as catalyst layers. Accordingly, the CNTs 28 may be directly formed on the conductive layers by using the above process. The plasma is a microwave plasma, and an electric field is vertically formed on the surfaces of the conductive layers 12 in order to align the orientations of the CNTs 28. Within the emitter holes 20 to which the conductive layers 12 are exposed, a number of CNTs 28 are formed like a brush on the conductive layers 12. In this way, the electron emission element 10 is completed.

An anode electrode 32 is formed on an anode substrate 31 made of a transparent material, e.g., glass, and is coated with fluorescent members 33 to 35 to thereby form a display portion 30. The outer boundaries of the cathode substrate 11 and the anode substrate 31 are bonded to each other by a sealing material in a state that those substrates are separated from each other by a spacer by a predetermined gap width. In this way, the electron emission element 10 and the display portion 30 are bonded together, and an image display device 1 is completed (reference is made to FIG. 1 or 2).

Operations of the image display device 1, the electron emission element 10 and the like in the present embodiment will be described with reference to FIGS. 1 and 2.

Predetermined voltages Va (e.g., 1 to 15 kV) and Vd (e.g., 0 to 100 V) are applied to the anode electrode 32, the conductive layers 12 as the cathode electrode, and the gate electrodes 16 as shown in FIG. 2, to thereby develop an electric field. The electric-field concentration part 25 of the gate hole part 22 is closer to the electron emission part than the remaining part of the inner surface thereof, and its tip is sharpened. Thus, the electric lines of force concentrate at the tips to develop an intensive electric field. Under the electric field, electrons are pulled out of the CNTs 28 and emitted from the tips of the CNTs 28. The gate electrodes 16 guide the electrons to be incident on the anode electrode 32 coated with the fluorescent members 33 to 35. In turn, the fluorescent members 33 to 35 are excited to emit light. The emitted light depicts a desired image, which is visually presented through the transparent anode substrate 31. The light emission can be controlled by matrix controlling the voltage applied to the gate electrodes 16 to thereby enable gradation display for each pixel.

The image display device 1 in the embodiment has the following useful effects.

In the embodiment, the lower end of the inner surface of the gate hole part 22 is extended inwardly to form the electric-field concentration part 25. The electric lines of force concentrate at the electric-field concentration part 25, thereby reducing the voltage required for electron emission. The lower end of the inner surface as the electric-field concentration part 25 is sharpened toward the inner side, i.e., toward the electron emission part. The tip area of the lower end is small, so that electrons are emitted with a low voltage. Since there is no need of thinning the entire gate electrodes 16, it never loses the function as the conductive layer. Further, the tips of the CNTs 28 are lower than the gate electrodes 16, and the lower end of the gate hole part 22 is minimized in diameter. As a result, the configuration of the gate hole part 22 is simplified. Accordingly, the electron emission element can be easily manufactured by merely using the mask 40 having the circular opening parts 41 each having the diameter reducing from the top end to the bottom end.

### Second Embodiment

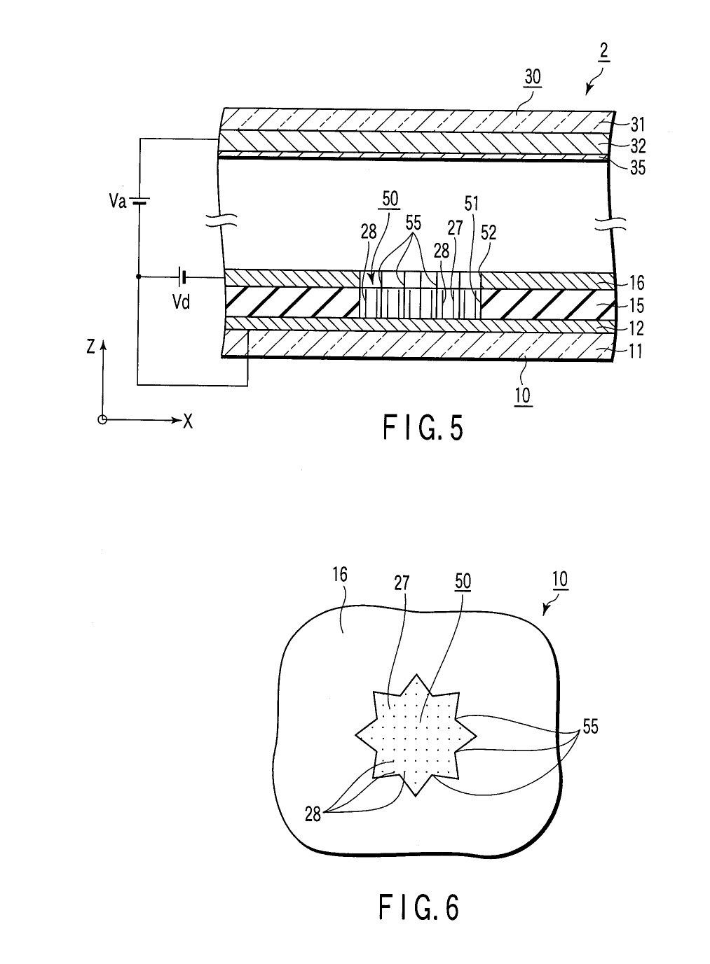

An electron emission element 10 according to a second embodiment of the present invention will be described with reference to FIGS. 5 and 6. In those figures, the portions of the second embodiment except emitter holes 50 are substantially the same as the corresponding ones in the first embodiment. Accordingly, like or equivalent portions of the present embodiment are designated by like reference numerals in the first embodiment, for simplicity.

As shown in FIGS. 5 and 6, in the electron emission element 10 of the present embodiment, a plurality of electric-field concentration parts 55 are provided, while being equidistantly separated from one another, on and along the inner circumference of each emitter hole 50. In other words, the emitter hole 50 is shaped like a star having a plurality of protrusions extending toward the center of the electron emission part as viewed in plane, as shown in FIG. 6. The tips of the protrusions form an example of the electric-field concentration parts 55. As shown in FIGS. 5 and 6, a configuration of the emitter hole 50 is substantially fixed in the thickness direction. As shown in FIG. 6, the protrusions are sharpened toward the center of the emitter hole 50 and its tip area is small.

To form the electron emission element 10 of the second embodiment, as in the first embodiment, the dry etching process is executed by using a mask (not shown) having star-like opening parts to etch away the insulating layer 15 and the gate electrodes 16 by predetermined amounts and to form emitter holes 50 each having a predetermined configuration.

Also in the second embodiment, the useful effects are produced which are comparable with those produced by the electron emission element 10 of the first embodiment. The second embodiment is provided with the plurality of electric-field concentration parts 55, which are located closer to the tips of the CNTs 28 than the remaining parts. Since the tip areas of the electric-field concentration parts 55 are small, the electric field easily concentrates at the tip areas. Accordingly, the CNTs are able to emit electrons with a low voltage. The electron emission element is easily manufactured by merely using a mask (not shown) having star-like openings in the dry etching process for forming the emitter holes 50. Since the plurality of electric-field concentration parts 55 are used, even if the electric-field concentration parts 55 may be manufactured having some variations in their configurations, the configuration variation could be removed by averaging the quantities of electrons emitted from the emitter holes 50.

In the second embodiment, the electron emission element 10 thus constructed may be coupled with the display portion 30 to complete an image display device 2 as in the first embodiment. The display portion 30 includes an anode substrate 31 and an anode electrode 32 and the like, which are provided on the anode substrate 31, as in the first embodiment. Those components are designated by like reference numerals in the cross-sectional view of the image display device in FIG. 5.

### Third Embodiment

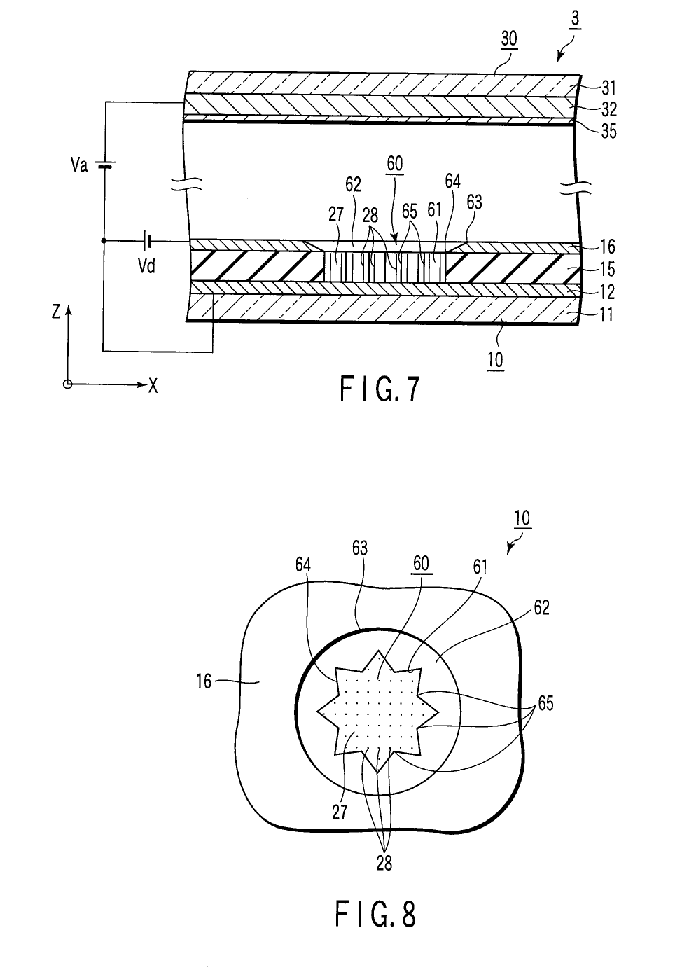

An electron emission element 10 which is a third embodiment of the present invention will be described with reference to FIGS. 7 and 8. In those figures, the portions of the third embodiment except emitter holes 60 are substantially the same as the corresponding ones in the first embodiment. Accordingly, like or equivalent portions of the third embodiment are designated by like reference numerals in the first embodiment, for simplicity.

In the electron emission element 10 of the third embodiment, as shown in FIG. 7, the upper end of a gate hole part 62 forms a large diameter part 63, and the lower end of the gate hole part 62 forms a small diameter part 64. As shown in FIG. 8, the large diameter part 63 is circular when viewed in plane. The small diameter part 64 of the lower end of the gate hole part 62 is radially and inwardly extended at a plurality of positions to form a star-like shape when viewed in plane. The lower end of the apex of each extended part forms one form of an electric-field concentration part 65. As shown in FIG. 8, an insulation hole part 61 is shaped like a star when viewed in plane, as in the second embodiment. Thus, the emitter hole 60 of the third embodiment is the combination of the features of the first and second embodiments. Each electric-field concentration part 65 is sharpened when viewed in the transverse-sectional view (see FIG. 8) in addition to the vertical-sectional view (see FIG. 7) and its tip is small in cross-sectional area.

In the third embodiment, the respective layers are dry etched up to the conductive layers 12 by using a given gas, while being masked with a mask (not shown) having star-like opening parts. Thereafter, the gate electrodes 16 are partially dry etched by using the mask 40 having the opening part 41 as shown in FIG. 4 to thereby form gate hole parts 62. In this way, the emitter holes 60 each having a predetermined configuration are formed.

The third embodiment is the combination of the first and second embodiments, whereby the tip area of each electric-field concentration part 65 is small. Each electric-field concentration part is sharpened in the longitudinal-sectional view (see FIG. 7) and the transverse-sectional view (see FIG. 8), and thus its tip is further small, and the voltage required for emitting electrons can be further reduced.

In the third embodiment, the electron emission element 10 thus constructed may be coupled with the display portion 30 to complete an image display device 3 as in the first embodiment. The display portion 30 includes an anode substrate 31 and an anode electrode 32 and the like, which are provided on the anode substrate 31, as in the first embodiment. Those components are designated by like reference numerals in the cross-sectional view of the image display device in FIG. 7.

### Fourth Embodiment

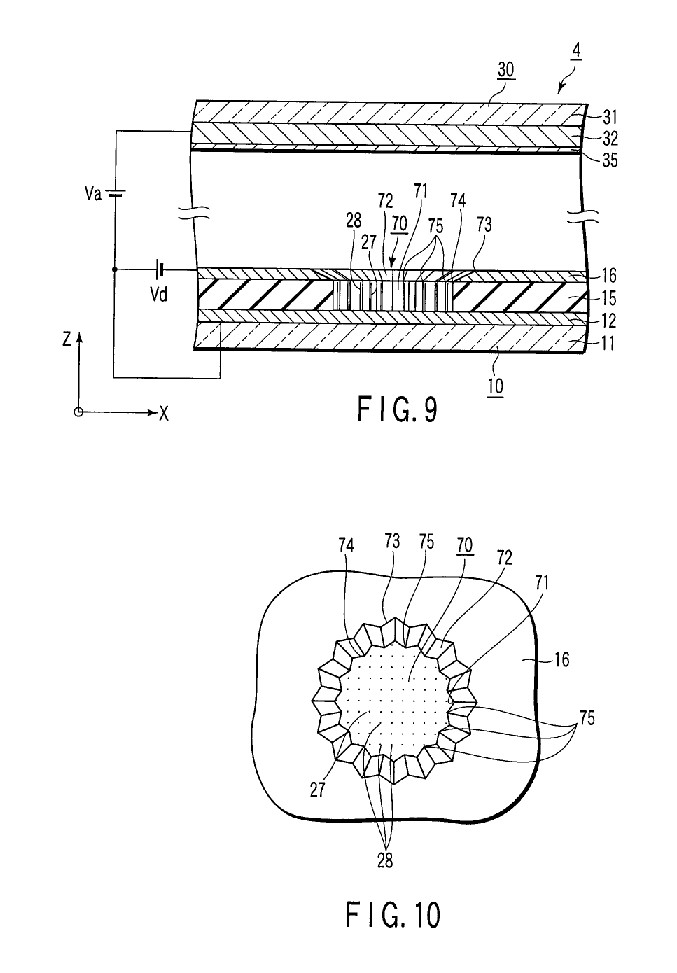

An electron emission element 10 according to a fourth embodiment of the present invention will be described with reference to FIGS. 9 and 10. In those figures, the portions of the fourth embodiment except a gate hole part 72 are substantially the same as the corresponding ones in the first embodiment. Accordingly, like or equivalent portions of the present embodiment are designated by like reference numerals in the first embodiment, for simplicity.

The gate hole part 72 in the emitter holes 70 of the fourth embodiment, as shown in FIG. 9, includes a large diameter part 73 at the upper end and a small diameter part 74 at the lower end. The gate hole part 72 is configured such that its opening diameter reduces toward the lower end, and it takes a star-like shape when viewed in transversal cross section (see FIG. 10). An apex of each extended part of the lower end is one form of an electric-field concentration part 75.

In the electron emission element 10 of the fourth embodiment, the respective layers are dry etched by using a given etching gas, while being masked with a mask (not shown) having opening parts each being shaped like a start and gradually reduced in diameter downward to thereby form the gate hole part 72. Subsequently, using a given etching gas, the insulating layer 15 is dry etched from the gate hole part 72 to the conductive layer 12 to thereby form emitter holes 70.

Also in the fourth embodiment, the useful effects are obtained which are comparable with those obtained by the electron emission element 10 of the third embodiment. Each electric-field concentration part is sharpened in the transverse direction as well as in the longitudinal direction, so that the tip area of the electric-field concentration part is made smaller and the voltage required for the electron emission is further reduced. The gate hole part 72 having a predetermined configuration are formed by one-time etching process, providing easy manufacturing of the electron emission element.

In the fourth embodiment, the electron emission element 10 thus constructed may be coupled with the display portion 30 to complete an image display device 4 as in the first embodiment. The display portion 30 includes an anode substrate 31 and an anode electrode 32 and the like, which are provided on the anode substrate 31, as in the first embodiment. Those components are designated by like reference numerals in the cross-sectional view of the image display device in FIG. 9.

### Fifth Embodiment

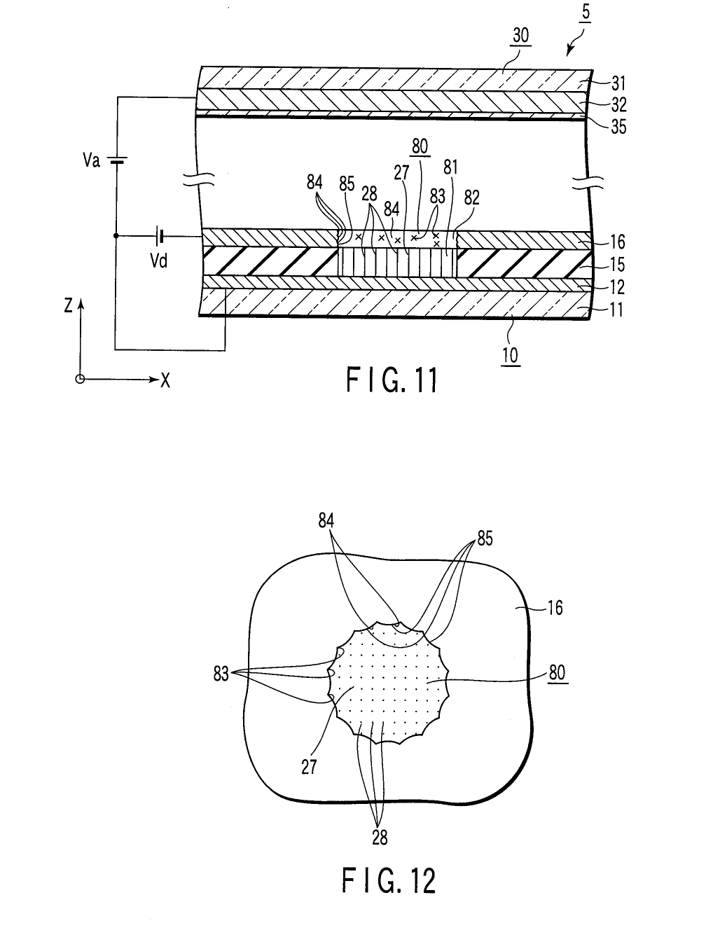

An electron emission element 10 according to a fifth embodiment of the present invention will be described with reference to FIGS. 11 and 12. In those figures, the portions of the fifth embodiment except gate electrodes 16 and emitter holes 80 are substantially the same as the corresponding ones in the first embodiment. Accordingly, like or equivalent portions of the present embodiment are designated by like reference numerals in the first embodiment, for simplicity.

The gate electrodes 16 in the fifth embodiment is made of a material easy to be fluorinated such as aluminum or ITO (indium oxide doped with tin). As shown in FIGS. 11 and 12, a plurality of recessed parts 83 and a plurality of protruded parts 84 each protruded relative to the recessed part 83 are substantially alternately arranged on the entire inner surface of the gate hole part 82 of the emitter hole 80. As shown in FIG. 12, when viewed in plane, the tip of each protruded part 84 relatively extending from the recessed part 83 to the center of the gate hole part 82 is one form of an electric-field concentration part 85.

In the electron emission element 10 of the present embodiment, the portions of the gate electrodes 16 on the insulating layer 15 are filmed over with a material, e.g., metal easy to be fluorinated. Thereafter, a mask having circular opening parts is formed on the film of such a material as in the first embodiment, for example. The portions of the gate electrodes 16 are then dry etched by a given etching gas by using the mask to form gate hole parts 82 Subsequently, the gate hole parts 82 is fluorinated with a fluorocarbon-based gas. In this instance, the insulating layer 15 is dry etched from the gate hole part 82 to the conductive layers 12 to form emitter holes 80. At this time, in the emitter holes 80, the surfaces of the gate electrodes 16 as the inner surfaces, which are exposed to the opened parts, i.e., the inner wall of the gate hole parts 82, are fluorinated. At this time, a number of protruded parts 84 are formed on the inner surfaces of the emitter holes 80 by the fluorination since the gate electrodes 16 are made of the material easy to be fluorinated. The tips of the protruded parts 84 fluorinated and relatively protruded to the center of the emitter holes 80 serve as the electric-field concentration parts 85.

In the electron emission element 10 of the present embodiment, the fluorinated portions are relatively protruded to the center of the inside of the gate hole parts 82. In such a case, the areas of the protruded parts mainly function for electric-field concentration and hence, the electric lines of force more concentrate thereat than in the case where the inner surface of the gate hole part 82 is flat. Therefore, the voltage required for emitting electrons is lowered. In the fifth embodiment, the gate electrodes 16 are filmed over with the material easy to be fluorinated, whereby easy manufacturing of the electron emission element 10 is ensured.

In the fifth embodiment, the electron emission element 10 thus constructed may be coupled with the display portion 30 to complete an image display device 5 as in the first embodiment. The display portion 30 includes an anode substrate 31 and an anode electrode 32 and the like, which are provided on the anode substrate 31, as in the first embodiment. Those components are designated by like reference numerals in the cross-sectional view of the image display device in FIG. 11.

### Sixth Embodiment

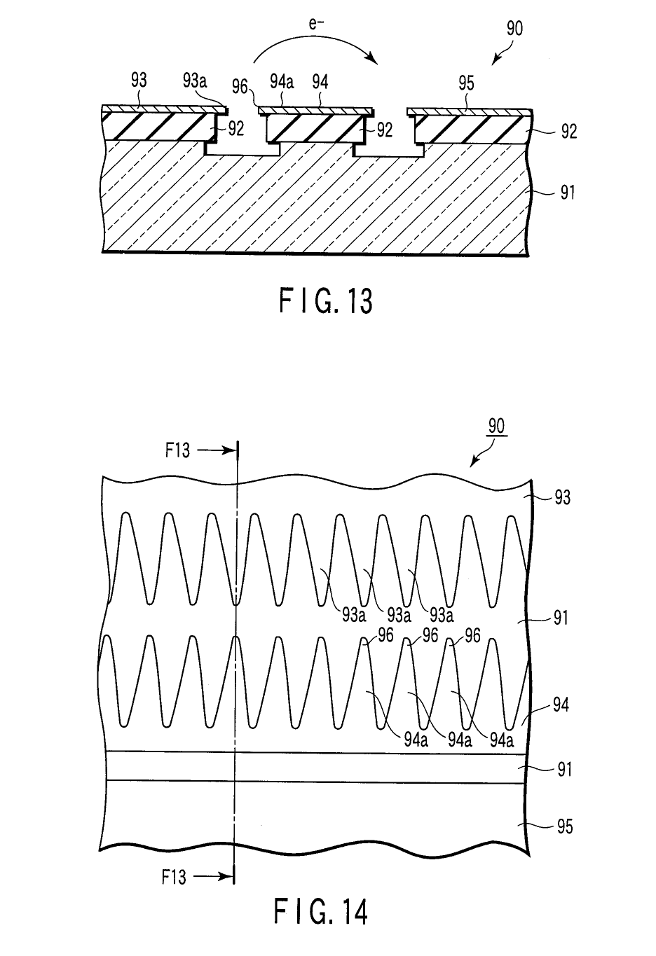

While the electron emission element of each of the first to fifth embodiments is of the vertical type in which the gate electrodes 16 as the second conductive layers are layered above on the conductive layers 12 as the first conductive layers, the present invention may be applied to a planar type of electron emission element 90 as shown in FIGS. 13 and 14. In the electron emission element 90 of the embodiment, as shown in FIG. 13, an insulating layer 92 is formed on a cathode substrate 91, and an electron emission layer 93 as a first conductive layer, a gate electrode 94 as a second conductive layer, and an anode electrode 95 are arranged side by side on the insulating layer 92. As shown in FIG. 14, when viewed in plane, a plurality of sharpened parts 93a as an electron emission part, which are sharply extended, are formed at the end of the electron emission layer 93, which is closer to the gate electrode 94. A plurality of sharpened protruded parts 94a are formed at the end of the gate electrode 94, which is closer to the electron emission layer 93. The tips of the protruded parts 94a serve as electric-field concentration parts 96. Also in the sixth embodiment, the voltage required for electron emission can be lowered as in the first embodiment.

In the embodiment, an image display device is constructed by coupling the electron emission element 90 thus constructed with a display portion for emitting light in response to emitted electrons.

It is clear that the present invention is not limited to the above-mentioned embodiments, but the components may be modified, altered or changed in implementing the invention. The three-electrode structure having the gate, cathode and anode electrodes is employed in each embodiment. A collection electrode including an insulating layer and a gate electrode may additionally be used.

In each embodiment, the diameter of the emitter hole 20 or the like is used for the reference for the distance from the electron emission part (example=CNTs 28). An average of the distances measured from the tips of the plurality of CNTs 28 formed in the emitter holes 20 may be used instead. In each embodiment, the CNTs 28 as the linear conductive members are formed for the carbon layers 27. Another material, e.g., amorphous carbon film or graphite material, may be used instead of the linear conductive members. The electron emission layer (e.g., carbon layers 27) may include a corn-shaped emitter in place of the linear conductive members. In each embodiment, the conductive layer 12 is made of nickel, but it may be made of a catalyst metal, such as cobalt, iron or an alloy of those materials. Further, the dry etching process for forming the emitter holes 20 and the like may be replaced with the wet etching process. It is evident that the electron emission element of the present embodiment may be applied to any other suitable device than the FED.

It is understood that the invention is not limited to the embodiments mentioned above, but it may be implemented by using the components modified, altered, or changed within the scope of the invention. An appropriate combination of the plurality of constituent components in the disclosed embodiments is allowed within the scope of the invention. Some components may be deleted from all the components described in the embodiments. Some of the different embodiments may be extracted and appropriately combined.

### Seventh Embodiment

An electron emission element 110, a method of manufacturing the electron emission element, and an image display device 101 having the electron emission element according to a seventh embodiment of the present invention, will be described.

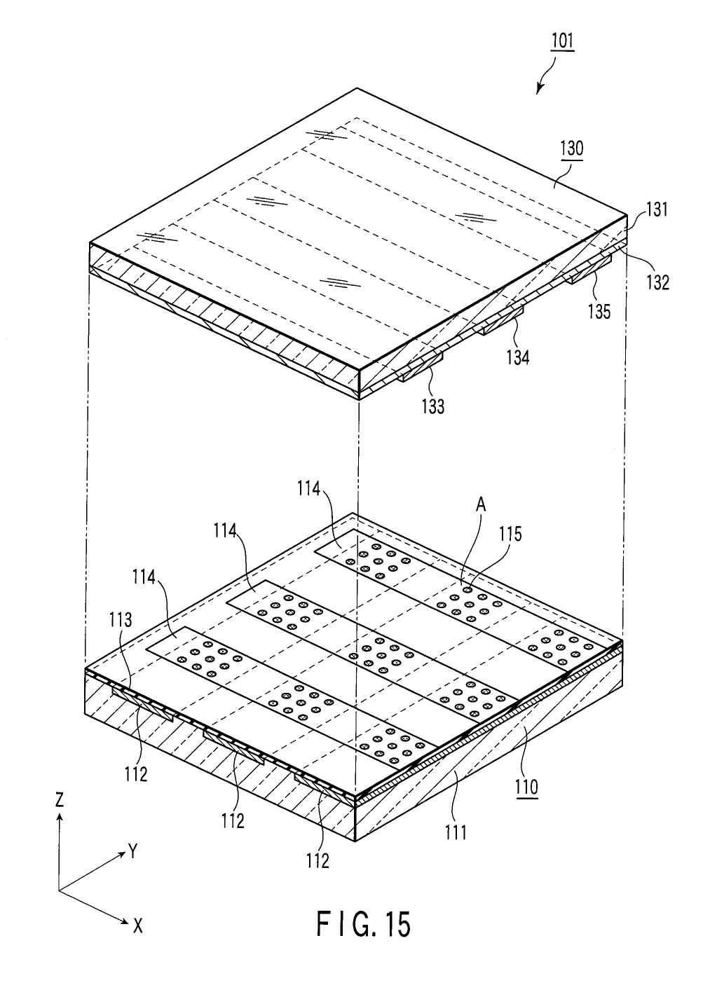

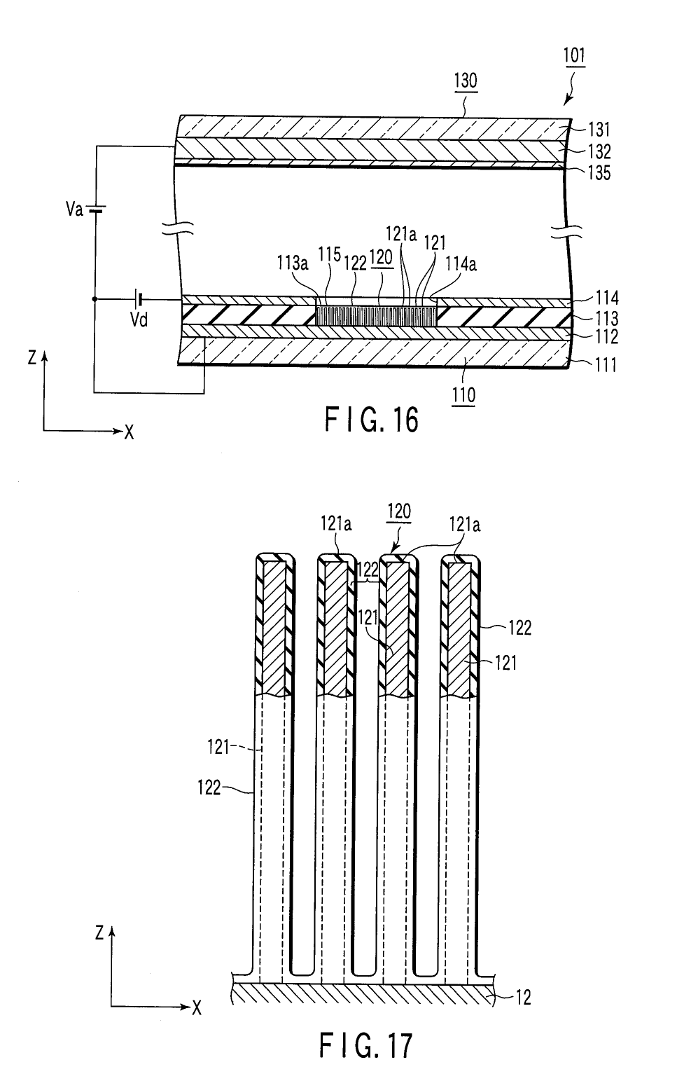

First, the image display device 101, the electron emission element 110 and the like according to the seventh embodiment of the invention will be described with reference to FIGS. 15 to 17. FIG. 15 is a perspective view showing a portion corresponding to one pixel in the image display device 101. FIG. 16 is an enlarged cross-sectional view showing a portion A of the image display device 101 of FIG. 15. FIG. 17 is a side view showing an electron emission part, partially cut out, in FIG. 16. Arrows X, Y and Z in FIGS. 15, 16 and 17 indicate three directions, which are orthogonal to one another. In those figures, the structure is illustrated while being appropriately enlarged, reduced or omitted, for ease of explanation.

As shown in FIG. 15, the image display device 101 as one form of a display device is generally composed of the electron emission element 110 and a display portion 130 for emitting light upon receipt of electrons emitted from the electron emission element 110. The electron emission element 110 and the display portion 130 are bonded to each other in a state that those are oppositely disposed with a given space therebetween.

The electron emission element 110 shown in FIGS. 15 and 16 is made up of a cathode substrate 111, a plurality of conductive layers 112 formed on the cathode substrate 111, an insulating layer 113 formed on the cathode substrate 111 and the conductive layers 112, and a plurality of gate electrode 114 formed on the insulating layer 113. Emitter holes 115 are formed in the insulating layer 113 and the gate electrodes 114. In each emitter hole 115, a carbon layer 120 as one form of an electron emission layer is formed on the conductive layer 112.

The cathode substrate 111 is made of glass, silicon or the like and has an area large enough to display an image.

In the embodiment, three conductive layers 112, for example, are formed on the cathode substrate 111 corresponding to one pixel. In an example, the conductive layers 112 are made of a catalyst metal such as nickel and each take a rectangular shape extending in the Y direction.

As shown in FIGS. 15 and 16, the insulating layer 113 is made of silicon oxide (SiO₂) or the like and is formed on the upper surfaces of the cathode substrate 111 and the conductive layers 112. The three gate electrodes 114 are made of aluminum or the like, and each take a rectangular shape extending in the X direction. Those gate electrodes are arrayed corresponding in positions to fluorescent members 133 to 135 of three colors. Those gate electrodes 114 are connected to a driving circuit and matrix controlled.

As shown in FIG. 15, an array of circular emitter holes 115 is formed in each of the crossing portions where the gate electrodes 114 cross the conductive layers 112, with the insulating layer 113 interlayered therebetween. As shown in FIG. 16, the emitter holes 115 are formed by removing only the gate electrodes 114 and the insulating layer 113 by etching process, for example.

As shown in FIGS. 16 and 17, a carbon layer 120 as an electron emission layer is formed on the conductive layer 112 within each emitter hole 115. The carbon layer 120 is formed with a number of CNTs 121, which rise, like a brush, toward the display portion 130, i.e., in the Z direction, and a coating film 122 as a coating material for covering the outer surfaces of the CNTs 121. The tips 121a of the CNTs 121 form an example of an electron emission part.

The CNT 121 is shaped like a roll of a graphene sheet. The CNT 121 is about 50 nm in diameter and about 1 μm in length, and has a high tolerance current density. The CNT 121 emits electrons upon application of low voltage in a pressure-reduced state. The tips 121a of the CNTs 121 as the electron emission part are lower than the gate electrodes 114. The outer surfaces of the CNTs 121 are covered with the coating film 122.

The coating film 122 is made of an oxide such as silicon oxide (SiO₂), which is harder to be oxidized than the CNTs 121. The coating film 122 has a predetermined thickness small enough to produce the tunnel effect, which is determined by a material quality, for example. In the present embodiment, it is selected to be a few nanometers. This coating film 122, which covers the outer surfaces of the CNTs 121, protects the CNTs 121 against the materials such as the residual gas in the pressure-reduced atmosphere.

In FIGS. 15 and 16, the display portion 130 includes the anode substrate 131, the anode electrode 132 formed on the anode substrate 131, and fluorescent members 133 to 135 of three colors R, G, and B, which are coated on the surface of the anode electrode 132. The anode substrate 131 is made of a transparent material such as glass, which is the same as of the cathode substrate 111, in order to secure good sealing in connection with the cathode substrate 111. The anode electrode 132, made of metal, e.g., aluminum, is formed facing the cathode substrate 111. The anode electrode 132 is connected to a driving circuit. The fluorescent members 133 to 135 of three colors are rectangular and extends in the X direction, and respectively arranged in opposition to the gate electrodes 114.

The electron emission element 110 and the display portion 130 are bonded with each other by securing a predetermined width of a gap therebetween with a spacer, not shown. The gap is in a pressure-reduced state, at about 10⁻⁸ torr, and this state is well maintained with a getter, not shown.

A method of manufacturing the electron emission element 110, which forms the embodiment of the invention described above, will be described hereunder with reference to FIG. 15 or 16.

To start, a nickel plate is attached to the cathode substrate 111 to form conductive layers 112. An insulating layer 113 is formed on the conductive layers 112 and the entire upper surface of the cathode substrate 111 on which the conductive layers 112 are not formed. A film made of a metal, e.g., aluminum, which is different from the catalyst metal of the conductive layers 112, is formed on the insulating layer 113 by a sputtering process to thereby form gate electrodes 114.

Emitter holes 115 are formed at predetermined positions such that the emitter holes pass through the gate electrodes 114 and the insulating layer 113 to allow the catalyst metal to be exposed through the holes. Specifically, a mask having circular opening parts is first placed on the gate electrodes 114. Thereafter, the gate electrodes 114 are dry etched by using a given etching gas and using the mask to form opening parts. Subsequently, the insulating layer 113 is dry etched up to the conductive layers 112 by using a given etching gas to thereby form emitter holes 115 each having a predetermined configuration.

After the emitter holes 115 are formed, the cathode substrate 111 is introduced into a vacuum container, not shown, and CNTs 121 are formed on the exposed conductive layers 112 by decomposing a mixture gas of methane and hydrogen with plasma. For example, the conductive layers 112 are made of a catalyst metal such as nickel. In this case, the conductive layers 112 serve as catalyst layers. Accordingly, the CNTs 121 may be directly formed on the conductive layers by using the above process. The plasma is a microwave plasma, and an electric field is vertically formed on the surfaces of the conductive layers 112 in order to align the orientations of the CNTs 121. Thus, within the emitter holes 115 to which the conductive layers 112 are exposed, a number of CNTs 121 are formed while rising in the Z direction, like a brush, on the conductive layers 112, whereby a carbon layer 120 is formed.

Subsequently, the outer surfaces of the CNTs 121 are filmed with silicon oxide by sputtering or vapor deposition process to thereby form a coating film 122. Even when the sputtering or the vapor deposition process is applied to the CNTs from the display portion 130 side and the outer surfaces of the CNTs 121 is not entirely but partially covered with the coating film 122, at least the tips 121a of the CNTs 121 serving as the electron emission parts are covered with the coating film 122. In FIG. 17, there is shown a state that the outer surfaces of the CNTs 121 are entirely covered with the coating film 122.

An anode electrode 132 is formed on an anode substrate 131 made of a transparent material, e.g., glass, and is coated with fluorescent members 133 to 135 to thereby form a display portion 130. The outer boundaries of the cathode substrate 111 and the anode substrate 131 are bonded to each other by a sealing material in a state that those substrates are separated from each other by a spacer by a predetermined gap width. In this way, the electron emission element 110 and the display portion 130 are bonded together, and an image display device 101 is completed.

Operation of the image display device 101 of the embodiment will be described with reference to FIGS. 15 and 16.

Predetermined voltages Va (e.g., 1 to 15 kV) and Vd (e.g., 0 to 100 V) are applied to the anode electrode 132, the conductive layers 112 as the cathode electrode, and the gate electrodes 114 as shown in FIG. 16, to thereby develop an electric field. Since the tips 121a of the CNTs 121 grown on the conductive layers 112 are narrow, electric lines of force concentrate at the tips. Under such a strong electric field, electrons are pulled out of the electron emission parts such as the tips 121a of the CNTs 121 and pass through the coating film 122 to outside. The gate electrodes 114 guide the electrons to be incident on the anode electrode 132 coated with the fluorescent members 133 to 135. In turn, the fluorescent members 133 to 135 are excited to emit light. The emitted light depicts a desired image, which is visually presented through the transparent anode substrate 131. The light emission is controlled by matrix controlling the voltage applied to the gate electrodes 114 to thereby enable gradation display for each pixel.

The electron emission element 110, the image display device 101, and others in the embodiment has the following useful effects.

The outer surfaces of the CNTs 121 are covered with the coating film 122 made of silicon oxide. The CNTs are not affected by the materials such as the residual gas in the pressure-reduced atmosphere. Accordingly, there is no chance that hydrogen, oxygen and the like contained in the residual gas are adsorbed to the surfaces of the CNTs 121 to oxidize the CNTs, and the quantity of emitted electrons is stabilized. Further, the coating film 122 prevents the materials in the atmosphere from degrading the surfaces of the CNTs 121. Accordingly, the function of the CNTs 121 as the electron emission parts is maintained for a long time.

In the conventional art, to prevent the adverse effect by the residual gas, the pressure of the atmosphere is reduced to be in high vacuum level to reduce the amount of the residual gas per se. The seventh embodiment relaxes the condition for pressure. In the conventional art, the pressure of the atmosphere must be reduced to about 10⁻¹⁰ torr. In the embodiment, it is about 10⁻⁴ torr. This results in reduction of cost for the pressure reduction.

Further, when the thickness of the coating film 122 is selected to be thin enough to produce the tunnel effect, e.g., a few nanometers, the insulating material, e.g., silicon oxide, may be used without impairing the electron emission performance.

The electron emission parts are located on the display portion 130 side. Accordingly, by applying the sputtering or vapor deposition process to the electron emission parts from the display portion 130 side, the electron emission parts, such as the tips 121a of the CNTs 121 extended to the display portion 130 side, are easily covered with the coating film 122.

### Eighth Embodiment

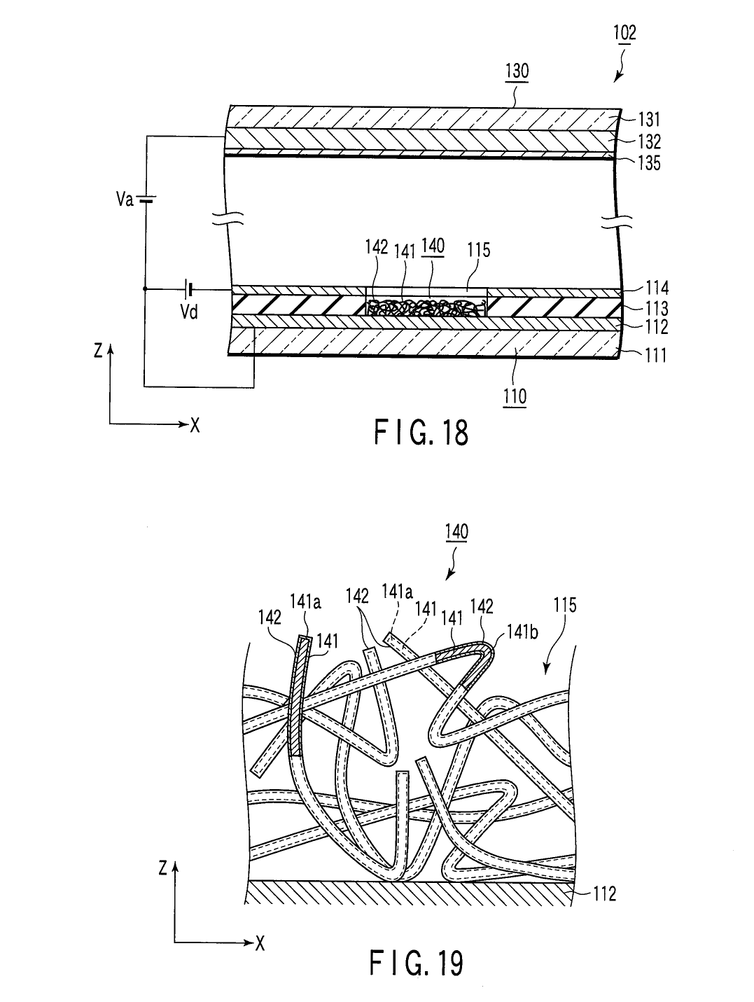

An electron emission element 110 and an image display device 102 according to an eighth embodiment of the present invention, will be described with reference to FIGS. 18 and 19. FIG. 18 is an enlarged cross-sectional view showing a portion of the image display device. FIG. 19 is a side view showing the electron emission parts, partially cut out, of FIG. 18. In those figures, the structure is illustrated while being appropriately enlarged, reduced or omitted, for ease of explanation. In those figures, in the image display device 102 of the eighth embodiment, the portions of the embodiment except carbon layers 140 are substantially the same as the corresponding ones in the image display device 101 of the seventh embodiment. Accordingly, like or equivalent portions of the present embodiment are designated by like reference numerals in the seventh embodiment, for simplicity.

The carbon layers 140 as the electron emission layers in the embodiment each contain a plurality of entangled CNTs 141. The CNTs 141 each include tips 141a and bending parts 141b. The tips 141a and the bending parts 141b, extending to the display portion 130 side form of examples of the electron emission parts. The outer surfaces of the CNTs 141 are covered with a coating film 142.

As in the seventh embodiment, the coating film 142 is made of an oxide such as silicon oxide (SiO₂), which is harder to be oxidized than the CNTs 121. The coating film 142 has a predetermined thickness small enough to produce the tunnel effect, which is determined by a material quality, for example. In the present embodiment, it is selected to be a few nanometers.

A method of manufacturing the electron emission element 110 and the image display device 102 according to the eighth embodiment of the invention, will be described with reference to FIG. 18 or 19. Other manufacturing steps than a step of forming the CNTs 141 are substantially the same as those in the seventh embodiment and hence, description thereof will be omitted.

To start, conductive layers 112 made of catalyst metal, insulating layer 113, and gate electrodes 114 are formed on the cathode substrate 111 made of glass, as in the seventh embodiment. Emitter holes 115 are formed at predetermined positions such that those holes pass through the gate electrodes 114 and the insulating layer 113 to expose the conductive layers 112 to outside. After the emitter holes 115 are formed, the cathode substrate 111 is introduced into a vacuum container, not shown, and CNTs 141 are formed on the exposed conductive layers 112 by decomposing a mixture gas of methane and hydrogen with plasma.

An electric field is vertically formed on the surfaces of the conductive layers 112 in order to align the orientations of the grown CNTs 121, in the seventh embodiment. In the eighth embodiment, this orientation alignment step is omitted, and the CNTs 141 are grown without vertically forming the electric field. In the emitter holes 115 where the conductive layers 112 are exposed, a plurality of bent and entangled CNTs 141 are formed on the conductive layers 112 to thereby form carbon layers 140.

Then, the outer surfaces of the CNTs 141 are filmed with silicon oxide by sputtering or vapor deposition process to form a coating film 142. At this time, the vapor deposition or sputtering process is applied to the electron emission parts from the display portion 130 side as in the seventh embodiment. Even when the coating film 142 is not formed on the entire surface of the CNTs, viz., it is partially formed, parts to be the electron emission parts such as the tips 141a and the bending parts 141b of the CNTs 141, which are extended to the display portion 130 side, are covered with the coating film 142. In FIG. 19, there is shown a state that the outer surfaces of the CNTs 141 are entirely covered with the coating film 142.

As in the seventh embodiment, an anode electrode 132 is formed on an anode substrate 131, and fluorescent members 133 to 135 are formed on the anode electrode 132 to thereby form the display portion 130. The outer boundaries of the cathode substrate 111 and the anode substrate 131 are bonded to each other by a sealing material in a state that those substrates are separated from each other by a spacer by a predetermined gap width. In this way, the electron emission element 110 and the display portion 130 are bonded together, and an image display device 102, partially illustrated in FIG. 18, is completed.

Also in the present embodiment, the useful effects are obtained which are comparable with those obtained by the electron emission element 110 and the image display device 101 of the seventh embodiment. Since the outer surfaces of the CNTs 141 are covered with the coating film 142, the CNTs 141 are not adversely affected by the materials such as the residual gas in the pressure-reduced atmosphere. Accordingly, the pressure condition is relaxed, and the cost for the pressure reduction can be reduced. Further, when the thickness of the coating film 142 is selected to be thin enough to produce the tunnel effect, e.g., a few nanometers, the insulating material, e.g., silicon oxide, may be used without impairing the electron emission performance. By applying the vapor deposition or sputtering process to the electron emission parts from the display portion 130 side, a necessary portion including the tips 141a and the bending parts 141b of the CNTs 141, which serve as electron emission parts and are extended to the display portion 130 side, is easily covered with the coating film 142.

Additionally, it is noted that there is no need of vertically applying the electric field in forming the CNTs 141. This feature simplifies the manufacturing process. Further, it is noted that the bending parts 141b as well as the tips 141a serve as the electron emission parts. This feature brings about an increased number of electron emission parts.

### Ninth Embodiment

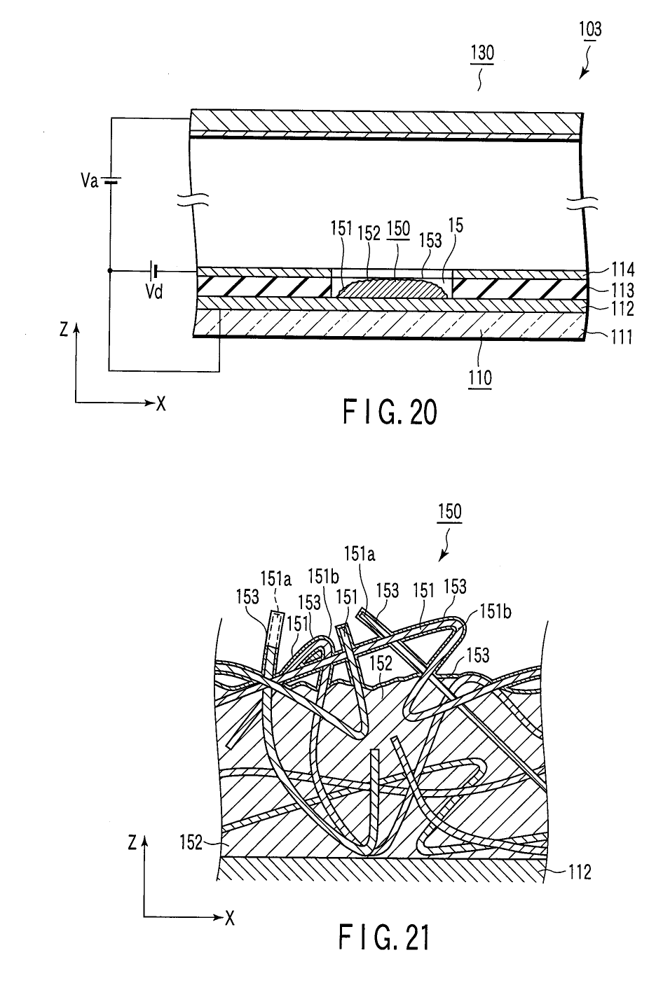

An electron emission element 110 and an image display device 103 according to a ninth embodiment of the present invention will be described with reference to FIGS. 20 and 21. FIG. 20 is an enlarged cross-sectional view showing a portion of the image display device 103. FIG. 21 is a side view showing the electron emission parts, partially cut out, of FIG. 20. In those figures, the structure is illustrated while being appropriately enlarged, reduced or omitted, for ease of explanation. In those figures, in the image display device 103 of the ninth embodiment, the portions of the embodiment except carbon layers 150 are substantially the same as the corresponding ones in the image display device 101 of the seventh embodiment. Accordingly, like or equivalent portions of the present embodiment are designated by like reference numerals in the seventh embodiment, for simplicity.

In the ninth embodiment, the carbon layers 150 as the electron emission layers are formed by printing method. As recalled, in the seventh embodiment, the conductive layers 112 are made of the catalyst metal since the CNTs 121 are grown directly on the conductive layers 112. In the present embodiment, other material than the catalyst material may be used for the conductive layers. The carbon layers 150 are formed of paste 152 formed by mixing the CNTs 151 into a metal material such as silver. The CNTs 151 are exposed on the surface of the paste 152. The CNTs 151 includes tips 151a and bending parts 151b as in the CNTs 141 in the eighth embodiment. The tips 151a and the bending parts 151b, which are extended to the display portion 130, serve as the electron emission parts. The outer surfaces of the CNTs 151 are covered with a coating film 153, as in the seventh and eighth embodiments.

The coating film 153 is made of an insulating material such as silicon oxide (SiO₂), which is harder to be oxidized than the CNTs 151, as in the seventh and eighth embodiments. The coating film 153 has a predetermined thickness small enough to produce the tunnel effect, which is determined by a material quality, for example. In the embodiment, the thickness is a few nanometers.

The electron emission element 110 and the image display device 103 according to the ninth embodiment will be described with reference to FIGS. 20 and 21. Other manufacturing steps than a step of forming the carbon layers 150 are substantially the same as those in the seventh embodiment and hence, description thereof will be omitted.

To start, as in the seventh embodiment, conductive layers 112, an insulating layer 113 and gate electrodes 114 are formed on the cathode substrate 111. Emitter holes 115 are formed at predetermined positions such that the emitter holes pass through the gate electrodes 114 and the insulating layer 113 to allow the conductive layers 112 to be exposed through the holes. Paste 152 containing silver particles and a frit component and further the CNTs 151 is applied for printing onto the surfaces of the conductive layers 112 in the emitter holes 115. The resultant is dried and burnt, and the surface of the paste 152 is irradiated with laser to expose the CNTs 151 to outside. Silver contained in the paste 152 may be replaced with another conductive material.

Subsequently, silicon oxide is sputtered or vapor deposited on the surfaces of the carbon layers 150 to form a coating film 153 as in the seventh embodiment. The surfaces of the exposed CNTs 151 and the paste 152 are covered with the coating film 153. As in the seventh embodiment, vapor deposition or sputtering process is applied to the assembly from the 130 side. Even when the outer surfaces of the CNTs 151 and the paste 152 are not entirely but partially covered with the coating film 153, at least the electron emission parts including the tips 151a and the bending parts 151b of the CNTs 151, which extend to the display portion 130 side, are covered with the coating film 153. A state that the electron emission parts are entirely covered with the coating film is illustrated in FIG. 21. Within the emitter holes 115, carbon layers 150 are formed in a state that a number of CNTs 151 are covered with the coating film 153 and exposed to outside.

As in the seventh embodiment, an anode electrode 132 is formed on an anode substrate 131, and the anode electrode 132 is coated with fluorescent members 133 to 135 to complete a display portion 130. The outer boundaries of the cathode substrate 111 and the anode substrate 131 are bonded to each other by a sealing material in a state that those substrates are separated from each other by a spacer by a predetermined gap width. In this way, the electron emission element 110 and the display portion 130 are bonded together, and an image display device 103, partially illustrated in FIG. 20, is completed.

Also in the present embodiment, the useful effects are obtained which are comparable with those obtained by the electron emission element 110 and the image display device 101 of the seventh embodiment. Since the outer surfaces of the CNTs 151 are covered with the coating film 153, the CNTs are not adversely affected by the materials such as the residual gas in the pressure-reduced atmosphere. Accordingly, the pressure condition is relaxed, and the cost for the pressure reduction can be reduced. Further, when the thickness of the coating film 153 is selected to be thin enough to produce the tunnel effect, e.g., a few nanometers, the insulating material, e.g., silicon oxide, may be used without impairing the electron emission performance. By applying the vapor deposition or sputtering process to the electron emission parts from the display portion 130 side, the electron emission parts including the tips 151a and the bending parts 151b of the CNTs 151, which are extended to the display portion 130 side, are easily covered with the coating film 153.

Since the printing method is used, the carbon layers 150 are easily formed.

### Tenth Embodiment

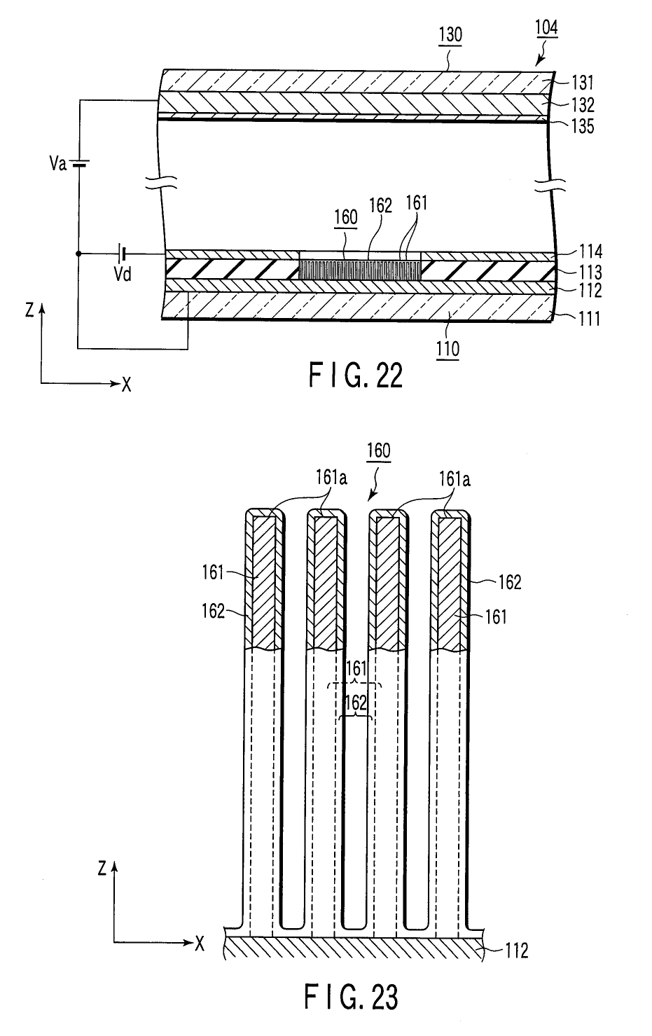

An electron emission element 110 and an image display device 104 according to a tenth embodiment of the present invention will be described with reference to FIGS. 22 and 23. FIG. 22 is an enlarged cross-sectional view showing a portion of the image display device. FIG. 23 is a side view showing the electron emission parts, partially cut out, of FIG. 22. In those figures, the structure is illustrated while being appropriately enlarged, reduced or omitted, for ease of explanation. In those figures, in the image display device 104 of the tenth embodiment, the portions of the embodiment except carbon layers 160 are substantially the same as the corresponding ones in the image display device 101 of the seventh embodiment. Accordingly, like or equivalent portions of the present embodiment are designated by like reference numerals in the seventh embodiment, for simplicity.

The carbon layers 160 in the present embodiment includes a number of CNTs 161, shaped like a brush, formed on the conductive layers 112 within the emitter holes 115, and a coating film 162 covering the outer surfaces of the CNTs 161. The coating film 162 is made of a conductive material, such as platinum or gold, which is harder to be oxidized than the CNTs 161. A thickness of the coating film 162 is about a few nanometers.

A method of manufacturing the electron emission element 110 and the image display device 104 according to the embodiment of the invention described above, will be described hereunder. Other manufacturing steps than a step of forming carbon layers 160 are substantially the same as those in the seventh embodiment and hence, description thereof will be omitted.

To start, as in the seventh embodiment, conductive layers 112, an insulating layer 113 and gate electrodes 114 are formed on the cathode substrate 111. Emitter holes 115 are formed at predetermined positions such that the emitter holes pass through the gate electrodes 114 and the insulating layer 113 to allow the catalyst metal to be exposed through the holes. After the emitter holes 115 are formed, the cathode substrate 111 is introduced into a vacuum container, not shown, and a number of CNTs 161 are formed on the exposed conductive layers 112 by decomposing a mixture gas of methane and hydrogen with plasma.

The outer surfaces of the CNTs 161 are filmed over with gold or platinum to form a coating film 162, by sputtering or vapor deposition process. Here, the carbon layers 160 are completed. In this case, the vapor deposition or sputtering process is applied from the display portion 130 side as in the seventh embodiment. Even when the outer surfaces of the CNTs 161 are not entirely but partially covered with the coating film 162, at least the electron emission parts including the tips 161a of the CNTs 161, which extend to the display portion 130 side, are covered with the coating film 162. A state that the surfaces of the CNTs 161 are entirely covered with the coating film 162 is illustrated in FIG. 23.

The display portion 130 is manufactured as in the seventh embodiment. The electron emission element 110 and the display portion 130 are bonded to each other in a state that those components are separated from each other by a spacer by a predetermined gap width. Here, an image display device 104, partially illustrated in FIG. 22, is completed.

Also in the present embodiment, the useful effects are obtained which are comparable with those obtained by the electron emission element 110 and the image display device 101 of the seventh embodiment. Since the outer surfaces of the CNTs 161 are covered with the coating film 162 hard to be oxidized, the electron emission parts are not adversely affected by the materials such as the residual gas in the pressure-reduced atmosphere. Accordingly, the pressure condition is relaxed, and the cost for the pressure reduction can be reduced. By applying the sputtering or vapor deposition process to the electron emission parts from the display portion 130 side, the electron emission parts extended to the display portion 130 side are easily covered with the coating film 162.

It is noted that in the present embodiment, the coating film 162 is covered with the conductive material such as gold or platinum. With this feature, the oxidization and degradation of the CNTs 161 are prevented without degradation of the electron emission characteristics even if it is formed thick.

In the description above, the technical concept involving the coating film 162 which is essential to the present embodiment is applied to the structure of the electron emission element 110 of the seventh embodiment. It is readily understood that the technical concept of the coating film 162 may be applied to the structures of the eighth and ninth embodiments.

### Eleventh Embodiment

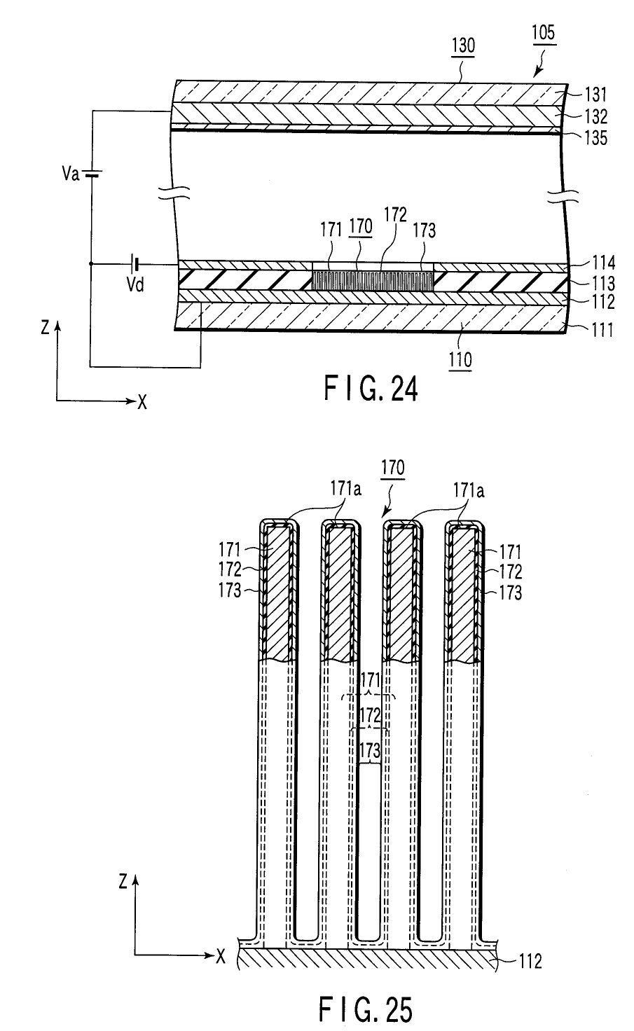

An electron emission element 110 and an image display device 105 according to an eleventh embodiment of the present invention will be described with reference to FIGS. 24 and 25. FIG. 24 is an enlarged cross-sectional view showing a portion of the image display device 105. FIG. 25 is a side view showing the electron emission parts, partially cut out, of FIG. 24. In those figures, the structure is illustrated while being appropriately enlarged, reduced or omitted, for ease of explanation. In those figures, in the image display device 105 of the eleventh embodiment, the portions of the embodiment except carbon layers 170 are substantially the same as the corresponding ones in the image display device 101 of the seventh embodiment. Accordingly, like or equivalent portions of the present embodiment are designated by like reference numerals in the seventh embodiment, for simplicity.

The carbon layers 170 of the present embodiment includes CNTs 171, a coating film 172 covering the outer surfaces of the CNTs 171, and a conductive film 173 as an example of a conductive covering material for covering the outer surface of the coating film 172.

A number of CNTs 171 are formed, like a brush, on the conductive layers 112 as in the seventh embodiment. The coating film 172 formed on the outer surfaces of the CNTs 171 are made of an insulating material such as silicon oxide as in the seventh embodiment. The conductive film 173 made of a conductive material, such as platinum or gold, which is harder to be oxidized than the CNTs 121, is formed on the outer surfaces of the coating film 172. The coating film 172 and the conductive film 173 each have a predetermined thickness small enough to produce the tunnel effect, which is determined by a material quality, for example. In the present embodiment, it is selected to be a few nanometers.

A method of manufacturing the electron emission element 110 and the image display device 105 according to the embodiment of the invention will be described. Other manufacturing steps than a step of forming the conductive film 173 are substantially the same as those in the seventh embodiment and hence, description thereof will be omitted.

To start, as in the seventh embodiment, conductive layers 112, an insulating layer 113, and gate electrodes 114 are formed on the cathode substrate 111. Emitter holes 115 are formed which pass through the insulating layer 113 and the gate electrodes 114 to expose the conductive layers 112 to outside. A number of CNTs 171 are formed on the conductive layers 112 within each emitter hole 115, and the outer surfaces of the CNTs 171 are filmed over with silicon oxide by sputtering or vapor deposition process to thereby form a coating film 172.

Further, in the embodiment, a conductive film 173 made of gold or platinum is formed on the outer surface of the coating film 172 by sputtering or vapor deposition process. At this time, the sputtering or vapor deposition process is applied from the display portion 130 side. Even when the coating film 173 is not always formed on the entire surface of the CNTs, viz., it is partially formed, the electron emission parts such as the tips 171a and the bending parts 171b of the CNTs 141, which are extended to the display portion 130 side, are covered with the coating film 172 and the conductive film 173. In FIG. 25, there is shown a state that the outer surfaces of the CNTs 171 are entirely covered with the coating film.

A display portion 130 is manufactured as in the seventh embodiment. The outer boundaries of the cathode substrate 111 and the anode substrate 131 are bonded together by a sealing material in a state that those substrates are separated from each other by a spacer by a predetermined gap width. In this manner, the electron emission element 110 and the display portion 130 are bonded to each other to complete an image display device 105, partially shown in FIG. 24.

Also in the present embodiment, the useful effects are obtained which are comparable with those obtained by the electron emission element 110 and the image display device 101 according to the seventh embodiment. Since the outer surfaces of the CNTs 171 are covered with the coating film 172 hard to be oxidized and the conductive film 173, the electron emission parts are not adversely affected by the materials such as the residual gas in the pressure-reduced atmosphere. Accordingly, the pressure condition is relaxed, and the cost for the pressure reduction can be reduced.

It is noted that the conductive film 173 made of the conductive material is additionally formed on the outer surface of the coating film 172. With this feature, even when an insulating material is contained in the coating film 172, the charge up does not occur and the performance of the electron emission parts is kept good.

In the description above, the technical concept involving the coating film 172 and the conductive film 173 which are essential to the present embodiment is applied to the structure of the electron emission element 110 of the seventh embodiment. It is readily understood that those films may be applied to the structures of the eighth and ninth embodiments.

In the embodiments mentioned above, the carbon layers 120, 140, 150, 160, and 170 as the electron emission layers are formed with the CNTs 121, 141, 151, 161 and 171. Graphite, graphite nanofiber, diamond, diamond-like carbon, silicon nanowire or the like may also be used for the carbon layer. While the conductive layers 112 are made of nickel in the above embodiments, a catalyst metal such as iron, cobalt or the like may be used instead. In the ninth embodiment, other material than the catalyst metal may be used.

In the embodiments, the coating films 122, 142, 153 and the like are made of silicon oxide. Magnesium oxide (MgO), diamond or the like may be used instead. The coating film 162 and the conductive film 173 are made of gold or platinum. Any other metal material than those metals may be used as long as it is hard to be oxidized.

It is understood that the invention is not limited to the embodiments mentioned above, but it may be implemented by using the components modified, altered, or changed within the scope of the invention. An appropriate combination of the plurality of constituent components disclosed in the embodiments is allowed within the scope of the invention. Some components may be deleted from all the components described in the embodiments. Some of the different embodiments may be extracted and appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of general inventive concept as defined by appended claims and their equivalents.

What is claimed is:

1. An electron emission element comprising:
a substrate;
a first conductive layer provided on the substrate;
an electron emission part formed on the first conductive layer;
an insulating layer formed on the first conductive layer and having a first opening part arranged such that the electron emission part is located within the first opening part; and
a second conductive layer formed on the insulating layer and having a second opening part such that the electron emission part is located within the second opening part,
wherein an electric-field concentration part which concentrates an electric field is provided within the second opening part.

2. The electron emission element according to claim 1, wherein the electric-field concentration part is an extended part, which extends to the inner side on the inner surface of the second opening part.

3. The electron emission element according to claim 1, wherein the inner surface of the second opening part is slanted such that the opening area of the second opening part gradually decreases toward the substrate, and
a difference between the minimum radius of a first end of the second opening part, which is closer to the substrate, and the maximum radius of a second end of the second opening part, which is opposite to the first end of the second opening part, is larger than a thickness of the second conductive layer.

4. The electron emission element according to claim 1, wherein the electron emission part contains a plurality of linear conductive members.

5. An electron emission element comprising:
a substrate;
a first conductive layer provided on the substrate via an insulating layer;
an electron emission part formed on the first conductive layer; and
a second conductive layer formed on the substrate via an insulating layer, while being separated from the first conductive layer in the plane direction of the substrate,
wherein an electric-field concentration part which concentrates an electric field is provided at a part of the second conductive layer, which faces the electron emission part.

6. A display device comprising:
an electron emission element including a substrate, a first conductive layer provided on the substrate, an electron emission part formed on the first conductive layer, an insulating layer formed on the first conductive layer and having a first opening part arranged such that the electron emission part is located within the first opening part, and a second conductive layer formed on the insulating layer and having a second opening part such that the electron emission part is located within the second opening part, wherein an electric-field concentration part which concentrates an electric field is provided within the second opening part; and
a display portion which receives electrons emitted from the electron emission part to emit light.

7. A display device comprising:
an electron emission element including a substrate, a first conductive layer provided on the substrate via an insulating layer, an electron emission part formed on the first conductive layer, and a second conductive layer formed on the substrate via an insulating layer, while being separated from the first conductive layer in the plane direction of the substrate wherein an electric-field concentration part which concentrates an electric field is provided at a part of the second conductive layer, which faces the electron emission part; and
a display portion which receives electrons emitted from the electron emission part to emit light.

8. A method of manufacturing an electron emission element comprising:
forming a first conductive layer on a substrate;
forming an insulating layer on the first conductive layer;
forming a second conductive layer on the insulating layer;
placing a mask, having an opening part with a predetermined shape, on the second conductive layer, etching the second conductive layer by using the mask, and forming an opening part with an extended part in the second conductive layer;
etching the insulating layer within the opening part to expose the first conductive layer; and
forming an electron emission part on the first conductive layer.

9. A method of manufacturing an electron emission element comprising:
forming a first conductive layer on a substrate;
forming an insulating layer on the first conductive layer;
forming a second conductive layer on the insulating layer;
placing a mask, having an opening part with a predetermined shape, on the second conductive layer, etching the second conductive layer by using the mask, and forming an opening part in the second conductive layer;
supplying a gas containing fluorine to the opening part to etch the insulating layer to expose the first conductive layer, and forming a part extending to the inner side of the opening part in the second conductive layer; and
forming an electron emission part on the first conductive layer.

10. An electron emission element comprising:
a substrate;
a conductive layer layered on the substrate;
an electron emission layer having an electron emission part formed on the conductive layer; and
a coating member which covers the electron emission parts and is made of a material harder to be oxidized than the electron emission part.

11. The electron emission element according to claim 10, wherein the electron emission layer contains at least one material selected from the group consisting of carbon nanotube, graphite, and graphite nanofiber.

12. The electron emission element according to claim 10, wherein the conductive layer contains iron, nickel, cobalt or an alloy containing at least one material among those materials.

13. The electron emission element according to claim 10, wherein the coating member is made of a material containing an oxide.

14. The electron emission element according to claim 10, wherein the coating member is made of a material containing a conductive material.

15. The electron emission element according to claim 10, wherein the coating member contains an insulating material, and
a conductive coating material is formed on the surface of the coating member, the conductive coating material being made of a conductive material harder to be oxidized than the surface of the electron emission part.

16. A method of manufacturing an electron emission element comprising:
forming a conductive layer on a substrate;
forming an electron emission layer with an electron emission part on the conductive layer; and
forming a coating member on the surface of the electron emission part, the coating member being harder to be oxidized than the surface of the electron emission part.

17. The method of manufacturing an electron emission element according to claim 16, wherein the coating member contains an insulating material, and
the method further comprises forming a conductive coating member, made of a conductive material harder to be oxidized than the electron emission part, on the surface of the coating member on the electron emission part.

18. A display device comprising:
an electron emission element including a substrate, a conductive layer layered on the substrate, an electron emission layer having an electron emission part formed on the conductive layer, and a coating member which covers the electron emission parts and is made of a material harder to be oxidized than the electron emission part; and
a display portion which receives electrons emitted from the electron emission part to emit light.
